(19) United States
(12) Patent Application Publication
(10) Pub. No.: US 2015/0039101 A1
(43) Pub. Date: Feb. 5, 2015

(54) Using Friction Compensation Modeling to Move a Control Project

(71) Applicant: Seagate Technology LLC, Cupertino, CA (US)

(72) Inventors: LingZhi Yang, Firestone, CO (US); Ju-il Lee, Eden Prairie, MN (US); Arnold Slezak, Fairlawn, OH (US)

(73) Assignee: Seagate Technology LLC, Cupertino, CA (US)

(21) Appl. No.: 13/956,080

(22) Filed: Jul. 31, 2013

(51) Int. Cl. G05D 3/00

(52) U.S. Cl. CPC G05D 3/00
USPC 700/56

(57) ABSTRACT

Apparatus and method for moving a control object, such as but not limited to a data read/write transducer adjacent a rotatable magnetic recording medium in a data storage system. In accordance with some embodiments, a compensation value is calculated for a baseline friction model which predicts friction in a positioning system. A modified friction model is generated based on the compensation value and the baseline friction model. A control object of the positioning system is moved from an initial position to a final position responsive to a trajectory profile calculated using the modified friction model.

### SUMMARY

Various embodiments of the present disclosure are generally directed moving a control object, such as but not limited to a data read/write transducer adjacent a rotatable magnetic recording medium in a data storage system.

In accordance with some embodiments, a compensation value is calculated for a baseline friction model which predicts friction in a positioning system. A modified friction model is generated based on the compensation value and the baseline friction model. A control object of the positioning system is moved from an initial position to a final position responsive to a trajectory profile calculated using the modified friction model.

These and other features and aspects which characterize various embodiments of the present invention can be understood in view of the following detailed discussion and the accompanying drawings.

### BRIEF DESCRIPTION OF THE DRAWINGS

FIG. 1 is a functional block representation of a data storage device in accordance with various embodiments.

FIG. 2 is a functional block representation of a data storage device corresponding to the device of FIG. 1 in accordance with some embodiments.

FIG. 3 shows a data read/write transducer moveable adjacent a rotatable data recording medium of FIG. 2.

FIG. 4 provides graphical representations of control profiles useful by the device of FIG. 2 during a velocity controlled seek.

FIG. 5 provides graphical representations of control profiles useful by the device of FIG. 2 during a model reference seek.

FIG. 6 is a functional block representation of a seek control assembly of the device of FIG. 2 in accordance with some embodiments.

FIG. 7 is a graphical representation of a friction model in accordance with some embodiments.

FIG. 8 represents a memory stack of FIG. 6 in accordance with some embodiments.

FIG. 9 is a graphical representation of another friction model in accordance with some embodiments.

FIG. 10 is a graphical representation of another friction model in accordance with some embodiments.

FIG. 11 is a graphical representation of another friction model in accordance with some embodiments.

FIG. 12 is a graphical representation of another friction model in accordance with some embodiments.

FIG. 13 is a flow chart for a CONTROL OBJECT POSITIONING routine illustrative of steps that may be carried out in accordance with various embodiments.

### DETAILED DESCRIPTION

Control systems are often used to move a control object from an initial position to a desired final position. In a hard disc drive for example, a closed loop servo control system can be used to move a data read/write transducer from a position adjacent an initial track to a position adjacent a destination track on a data storage medium (disc).

Different types of movement operations (seeks) can be performed. Some systems use one form of seek profiling for relatively long seeks, such as a velocity-controlled profile, and a different form of seek profiling for relatively shorter seeks, such as a model reference profile.

While operable in efficiently achieving the goal of moving the control object to the destination position, some amount of error can be present from a variety of sources. The error can increase the settle time as the control object settles onto the destination position.

One source of error in a rotary system relates to pivot-based friction. A rotary actuator in a hard disc drive often pivots about a cartridge bearing assembly mounted adjacent the outermost diameter (OD) of a disc stack, and has one or more cantilevered actuator arms that support data transducers adjacent the various data recording surfaces. Bi-directional seeks (e.g., toward the OD and toward the innermost diameter, ID) can induce non-uniform hysteresis effects in the friction model for the cartridge bearing assembly. While the seek profiles can take such friction models into account, errors in the predicted friction levels from a friction model can increase error and result in excessive settling times.

Accordingly, various embodiments of the present disclosure are generally directed to improvements in the positioning of a control object. As explained below, some embodiments use a compensated friction model to carry out the positioning of the control object from an initial position to a destination position.

A friction model module uses a baseline friction model to provide a baseline predicted friction response, generates a compensation value to account for at least one state value associated with the system, and uses the compensation value to adjust the baseline friction model to arrive at the compensated friction model.

The compensated friction model provides a friction estimate value that can be used in the control effort to move the control object to a target position. In this way, efficient control efforts can be expended to move the control object, and settling time can be reduced. It is contemplated that the control object may be a read/write data transducer adjacent a rotatable data recording medium, although such is not necessarily limiting.

In some embodiments, the baseline friction model can be based on the so-called Dahl model or the so-called Leuven (Swevers) model. The Dahl model is computationally elegant, but it has been found that the Dahl model can introduce significant error in shorter length seeks. The Leuven model is more computationally intensive and is associated with other limitations such as increased errors for relatively longer seeks. Compensation terms for these (and other) models can be derived in a variety of ways, depending on the requirements of a given application.

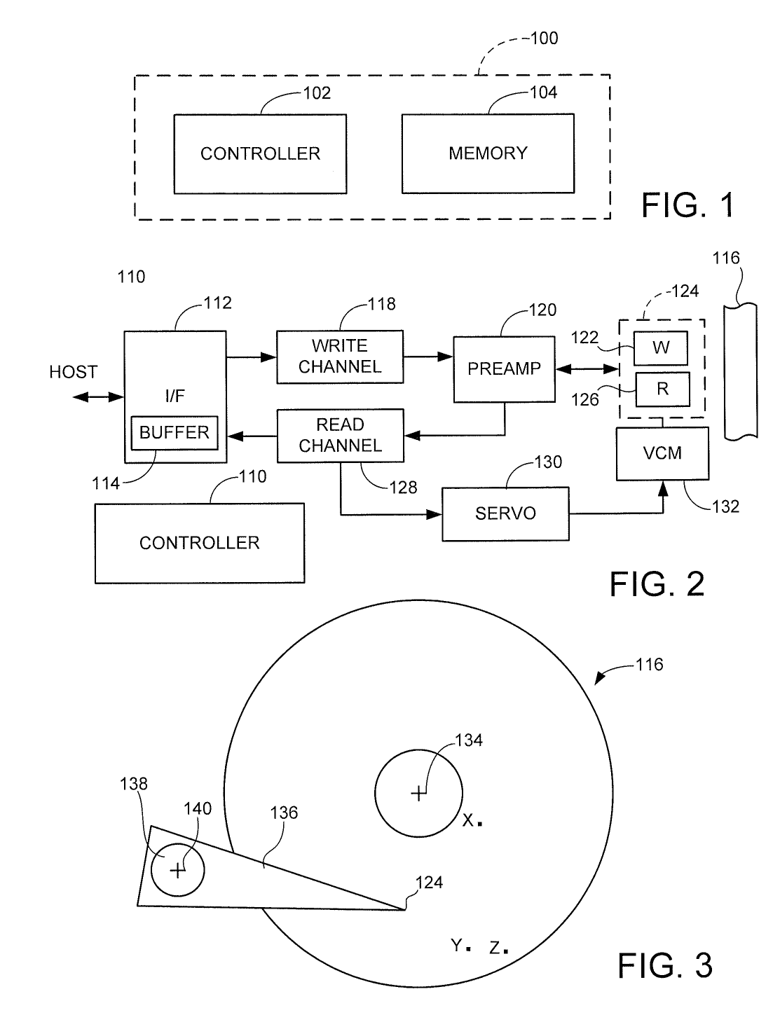

These and other features of various embodiments disclosed herein can be understood beginning with a review of FIG. 1 which provides a functional block representation of a data storage device 100. The device 100 includes a controller 102 and a memory 104. The controller 102 can take a variety of forms such as a hardware based control circuit or a general purpose programmable processor having suitable programming to provide top level control for the device. The memory 104 can take a variety of forms such as one or more magnetic recording media (discs).

FIG. 2 is a functional block diagram for another data storage device 110 that may represent the device 100 of FIG. 1. The data storage device 110 is characterized, for purposes of the present disclosure, as a hard disc drive (HDD) that employs perpendicular magnetic recording to store data from a host device (not separately shown). Such is merely exemplary and is not limiting.

The device 110 in FIG. 2 includes a top level controller 112 that may be realized in hardware or firmware. An interface circuit (I/F) communicates with the host device and includes a data buffer 114 to temporarily store data pending transfer between the host device and a perpendicular data recording medium 116.

A write channel 118 operates to encode input write data from the host to provide a serialized data stream to a preamplifier/driver (preamp) 120. The preamp 120 provides a sequence of write currents to a write element (W) 122 of a data transducer 124 to write data to the medium 116.

During a read operation, data signals are transduced by a read element (R) 126 of the data transducer and supplied to the preamp 120. The preamp conditions and amplifies the readback signals and provides the same to a read channel 128. The read channel 128 applies signal processing techniques to recover the originally stored data to the buffer 114 pending subsequent transfer to the host.

During both read and write operations, specially configured servo positioning data provided to the medium 116 are transduced by the read element 126 and, after demodulation by a portion of the read channel 128, are supplied to a servo control circuit 130. The servo control circuit 130 provides positional control signals to a voice coil motor (VCM) 132 coupled to the data transducer 124 to position the respective write and read elements 122, 126 adjacent various data tracks defined on the medium 116.

FIG. 3 depicts an arrangement of the medium 116 of FIG. 2 in accordance with some embodiments. The medium 116 is characterized as a magnetic recording disc which is rotated at a selected rotational velocity by a spindle motor (not shown) about a central axis 134. A plurality of concentric tracks (not separately shown) is defined on the media surface to store data from the host in the form of data sectors.

A rotary, bi-directional actuator 136 supports the data transducer 124 adjacent the recording surface of the medium 116. The actuator 136 pivots by way of a cartridge bearing assembly 138 about an actuator pivot point 140. The cartridge bearing assembly 138 can take a variety of forms and may include one or more sets of bearing races and ball bearings that facilitate rotation of the actuator 136 about a stationary, central shaft aligned with the pivot point axis.

Movement operations (seeks) can be carried out by commanding the VCM 132 (FIG. 2) to adjust the angular orientation of the actuator 136, and hence the radial position of the associated transducer 124, to various destination locations. Some locations may be located near the ID of the recording surface, such as location X. Other locations may be disposed near the OD of the recording surface, such as locations Y and Z. Short seeks involving a relatively small number of intervening tracks may be carried out between adjacent locations such as Y and Z. Long seeks involving relatively larger numbers of intervening tracks may be carried out between distal locations such as between X and Y and between X and Z.

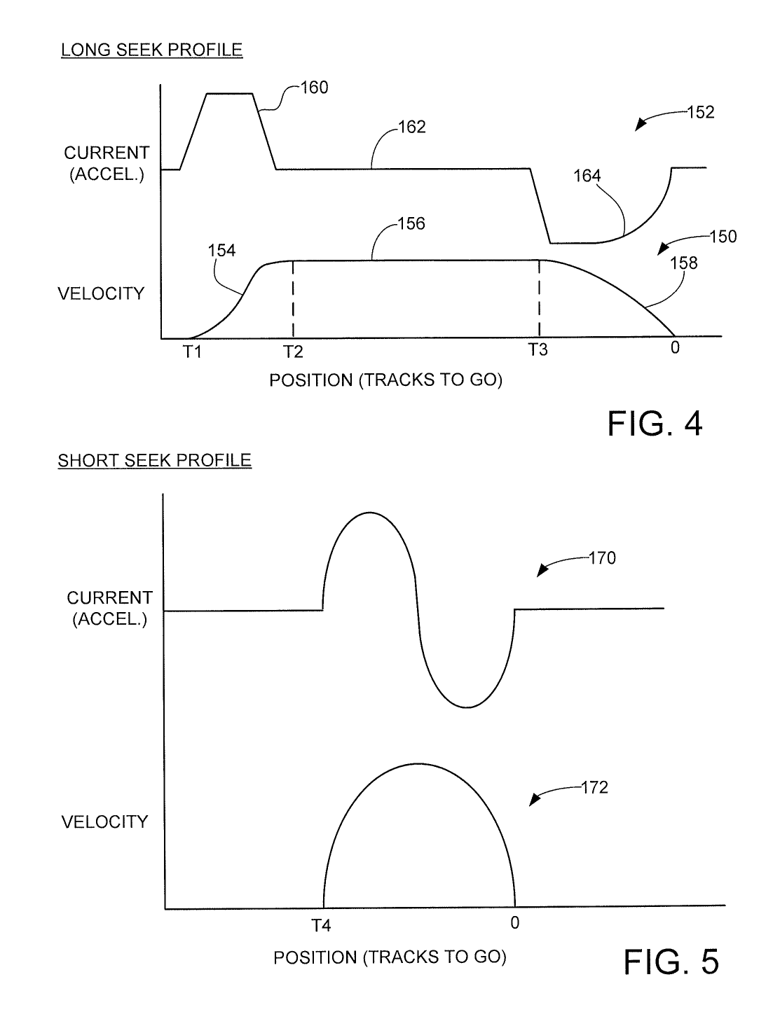

In some embodiments, the device 110 may be adapted to utilize different seek profiles for different lengths of seeks. FIG. 4 provides an illustrative example of a velocity controlled approach for long seeks. Curve 150 depicts a velocity profile that the transducer 124 is nominally caused to follow from an initial location T1 to a final destination, denoted as location 0. The x-axis is denoted in terms of “tracks-to-go” so that the total number of tracks covered by the seek is T1.

Curve 152 provides a corresponding acceleration profile that generally indicates the current that is applied to initially accelerate, and then decelerate, the transducer. In some cases, an initial acceleration phase (portion 154 of curve 150) is tailored to quickly accelerate the transducer to a maximum velocity (portion 156 of curve 150) while reducing excitation of system resonances. The transducer coasts at this velocity until a deceleration phase (portion 158 of curve 150) is reached, at which point a controlled deceleration of the transducer is undertaken to efficiently bring the transducer to rest on the destination track 0.

These respective velocities are achieved by a relatively large current pulse 160 having a first polarity to initiate acceleration of the transducer to the maximum velocity, after which acceleration (and current) are reduced to substantially zero (portion 162). A second relatively large current pulse 164 is subsequently applied to initiate deceleration and bring the transducer onto the destination track. It will be appreciated that the curves 150, 152 are generalized and can take a variety of different shapes. Other long seek methodologies besides velocity-controlled seeks can be utilized.

FIG. 5 illustrates another seek profile that may be carried out for seeks of shorter length. The seek profile in FIG. 5 is referred to as a model-reference seek and it includes a substantially sinusoidal current (acceleration) profile 170, which may take a number of forms including a 1-cosine form. The corresponding velocity profile is indicated by curve 172. Other reference waveforms, such as a position reference profile (not separately shown) can also be used during the model-reference seek. As before, the curves 170, 172 are generalized and can vary as required.

The transition point between long and short seeks can vary, but may be on the order of M tracks, so that seeks of seek length L<M use the model reference approach of FIG. 5 and seeks of L>M use the velocity-controlled approach of FIG. 4. One suitable value for M may be on the order of about 100 tracks (M=100) although other values can be used.

In each case, a variety of inputs are provided to initialize and carry out a particular seek. One parameter that can play a significant role during seek operations is friction associated with the cartridge bearing assembly 138 (see FIG. 3). As will be appreciated, cartridge bearing friction provides a countering force to the application of current and the initiation of rotation of the actuator 136 about the pivot point 140 (FIG. 3).

Generally, a higher amount of friction will mean that more control effort is required to achieve a given amount of acceleration/velocity. A lower amount of friction will generally require less control effort to achieve that same amount of acceleration/velocity. It follows that an accurate assessment of cartridge bearing friction is desirable since errors in the estimated friction provided by the cartridge bearing assembly may introduce corresponding errors in the control trajectory of the transducer, potentially leading to extended seek and settle times and delays in data I/O transfers.

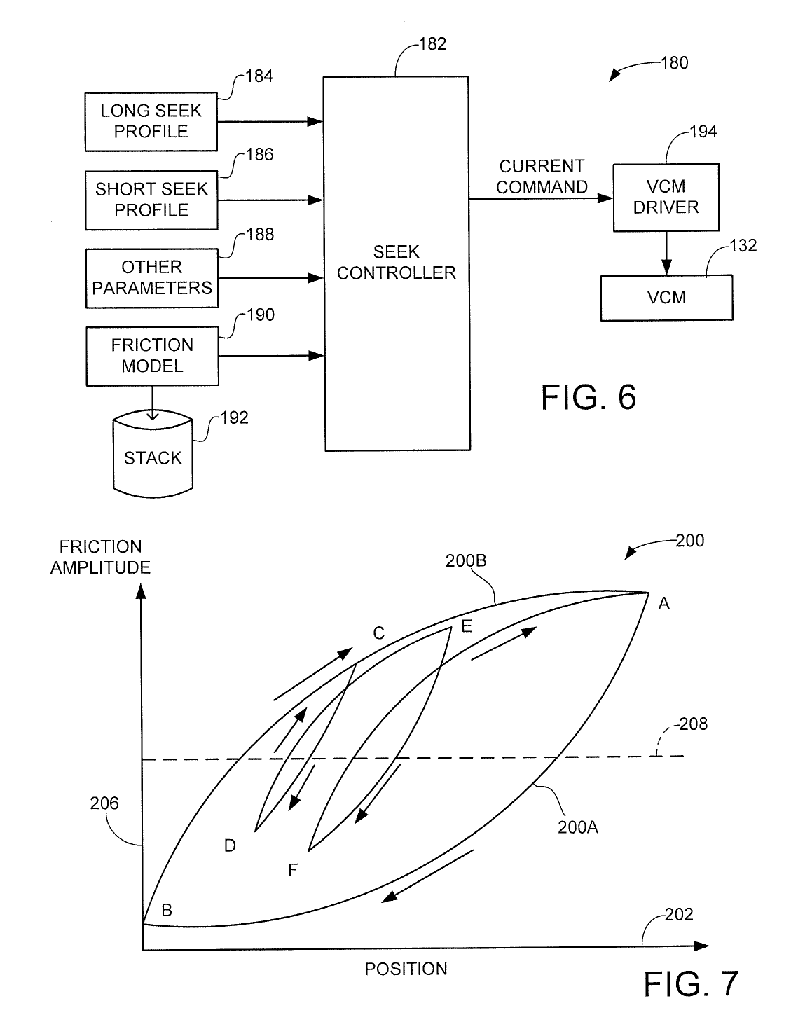

FIG. 6 shows a seek control assembly 180 configured to carry out seeks of the actuator 136 in accordance with some embodiments. A seek controller 182 may form a portion of the servo control circuit (130, FIG. 2) and receive inputs from a variety of reference blocks. A long seek profile block 184 supplies long seek parameters as discussed above in FIG. 4, and a short seek profile block 186 supplies short (model-reference) seek parameters as discussed above in FIG. 5. Other system parameters are provided by block 188 such as current and destination locations, current radial velocity (if any), associated zones, radial direction of most recent seek, angular location of the medium, temperature, etc.

A friction model block 190 supplies estimated (modeled) friction values at different sample times during these respective types of seeks. The friction model block 190 may utilize a memory stack 192 as part of the friction modeling process. Various embodiments presented below provide a number of related ways to obtain friction estimates from the block 190. While not limiting, the various friction models discussed below focus on bias components of friction and not necessarily other components that may be experienced by a system, such as viscous friction components. Nevertheless, it has been found that the system of FIG. 6 can provide improved servo control and repeatability over conventional approaches.

The seek controller 182 operates responsive to the respective inputs from blocks 184-190 to generate current command signals for a VCM driver 194, which in turn applies current to the VCM 132 (FIG. 2) to rotate the actuator 136 about the pivot point 140 (FIG. 3) in the desired direction. While not specifically depicted in FIG. 6, during the course of a particular seek, feedback such as in the form of transduced servo signals are supplied back to the seek controller to provide closed loop control. An observer function of the seek controller (not separately depicted) may provide various system state estimates based on this feedback.

Different styles and types of modified friction models can be provided by the friction model block 190. FIG. 7 is a graphical representation of a friction curve 200 in accordance with some embodiments. The curve 200 is plotted against a position x-axis 202 and a friction amplitude y-axis 204. The curve 200 generally corresponds to the Dahl friction model, and provides estimated friction values for different seeks.

Various seek paths are represented by the curve 200, with the differences between different points accounting for hysteresis from friction in the device 100. The hysteresis can arise due to a variety of factors. The model predicts that the friction experienced by the system in moving from point A to point B will generally correspond to the lower curved portion 200A, and the friction in moving from point B to point A will generally correspond to the upper curved portion 200B. Seeks to intermediate locations C, D, E and F will similarly be modeled by the associated curve segments.

While operable in modeling friction for relatively longer length seeks (e.g., between points A and B), the modeling represented by FIG. 7 has been found to introduce errors for shorter length seeks (e.g., between points C-F). It is contemplated that greater relative errors in shorter seek modeling may relate to non-linear factors such as bearing deformation, lubricant (e.g., grease) inconsistencies and dislocation, temperature, etc. all of which may tend to have less of an impact during longer seeks.

It follows that the model curve 200 only provides symmetrical behavior between points A and B; that is, beginning at A, and moving to B, and then returning to A will result in the friction bias forces (generally) following portions 200A and 200B, and the final friction force will nominally be the same as the initial force at the beginning of the seek. Stated another way, curve 200B is symmetric with curve 200A about a midline 208 (shown in dotted line fashion), whereas the smaller loops between points C-F are not. It has been found from empirical analysis that shorter seeks, such as to points C-F, will result in errors in the final bias force amounts provided by the model. One reason this is relates to the fact that the loops provided by C-D and E-F are not symmetrical. Another reason is that these smaller interior loops have different slopes as compared to the main segments between A-B.

The base Dahl model as exemplified by curve 200 can be represented as:

B_{new}=[B_{dirChange}−B_{c}sgn(Δx)]α(|⊕x|)+B_{c}sgn(Δx) (Eq. 1)

where B_{new}, is the bias hysteresis prediction for the next position, B_{dirChange} is the bias hysteresis prediction at the last velocity reversal, B_{c} is one half of the separation between the OD and ID bound bias curves, α(|Δx|) is an alpha table providing the initial slope of the hysteresis curve, Δx is the distance since last direction change, and −B_{c}sgn(Δx) is the bias hysteresis prediction for travel of the actuator across the complete hysteresis region prior to direction change.

The alpha table provides a slope table of each portion (transition curve) in the curve 200. Since B_{dirChange} is not the same at each velocity reversal when there is incomplete travel across hysteresis region prior to direction change, the alpha table should not be applied directly, as this could lead to different slopes.

In accordance with various embodiments, a modified Dahl model for a short seek is provided as follows:

B_{new}=[−B_{c}sgn(Δx)−B_{c}sgn(Δx)]α(|Δx|)+B_{c}sgn(Δx) [symbol] (1)−(−B_{c}sgn(Δx))+B_{dirChange} [symbol] (2) (Eq. 2)

where term (1) assumes complete travel across the region prior to velocity reversal, and term (2) provides an adjustment to account for the real B_{dirChange}.

One way to characterize the model provided by equation 2 is that the alpha table is used to describe the transition curves, and all the transition curves have the same shape, except starting from different points, which is defined by the term B_{dirChange}.

Accordingly, in some embodiments the friction model block 190 in FIG. 6 operates in accordance with equation 2 during a seek to provide improved friction inputs to the seek controller. This can be used for all seek lengths. Alternatively, equation 2 can be used for relatively shorter seeks and equation 1 can be used for relatively longer seeks. The transition cutoff can be derived empirically and may or may not correspond to the transition between different seek methodologies (e.g., velocity v. model-reference seeks). For example, short model-reference seeks may utilize equation 2 and long model-reference seeks (and velocity profile seeks) may use equation 1.

In further embodiments, non-local memory (NLM) capabilities may be incorporated into the modified Dahl friction model. A hysteresis behavior with non-local memory can be defined as an input-output relationship for which the output at any time instant not only depends on the output at some instant in the past and the input since then, but also on past extreme values of the input or output as well.

Another friction model, sometimes referred to as the Leuven model, incorporates non-local memory with three (3) primary constraints. First, a new transition curve is started at each velocity reversal. Second, the effect of the hysteresis behavior is removed at the closing of an internal loop; that is, if a hysteresis loop is closed, the loop is removed from the hysteresis memory, and the future hysteresis behaves as if this closed loop never occurred. Third, the hysteresis model is reset when the hysteresis friction force reaches a maximum (or minimum value); that is, the hysteresis transition curves which lie within the outmost hysteresis loop are removed.

The first and third constraints listed above are already present in the modified Dahl model of equation 2. Addition of the second constraint (removal of hysteresis effects upon closing of an internal loop) can be provided by further modifying the friction model from equation 2 as follows.

First, upon each direction change, the position and bias force at the changed location are saved to a memory location (stack location, such as in stack 192 in FIG. 6). Second, when providing a friction bias force prediction for the next position, trim the stack if the new position is going to pass the location saved in the stack. The trimming can involve two steps: first, reduce the stack length by two (2) entries, followed by refreshing B_{dirChange} and Δx using the value saved at the end of the stack before applying the formula.

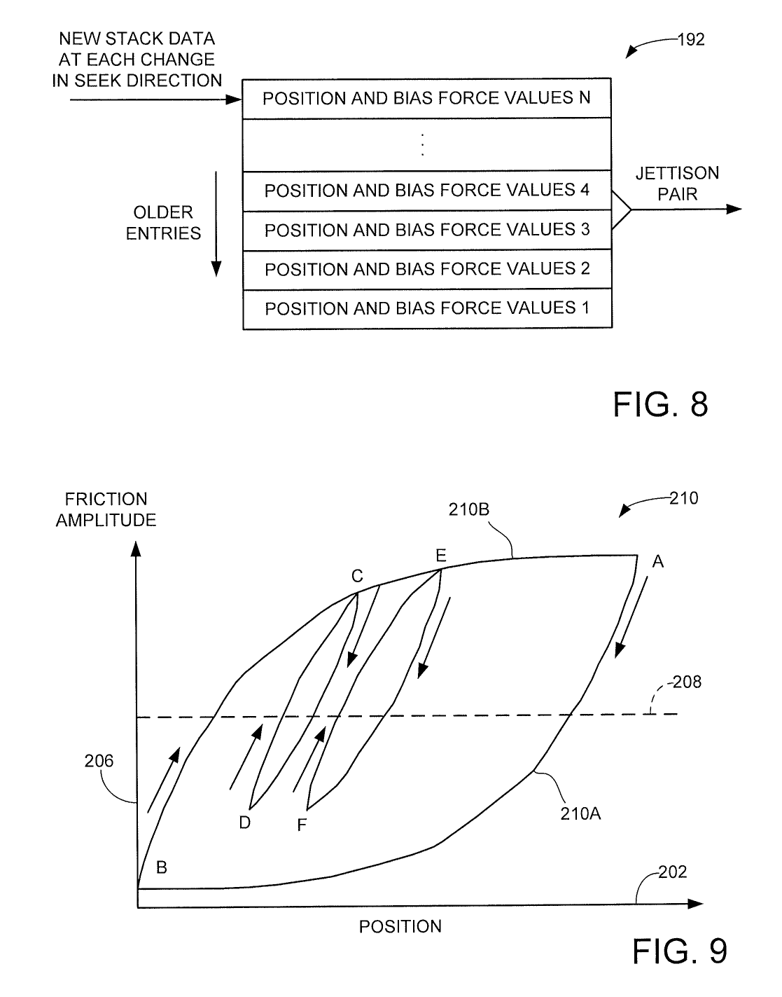

The operation of the stack 192 is represented in FIG. 8 for stack values 1 through N. Each change in seek direction results in a most recent position and bias force value being added to the stack. If the stack is filled, the oldest values in the stack are jettisoned. Intermediate pairs of values (such as values 3 and 4) are jettisoned if the new position moves beyond the positions represented by the pair, as shown. While not expressly represented in FIG. 8, the stack 192 can further be adapted to store the distance of each associated seek, as well as other parameters useful in the friction modeling process.

FIG. 9 provides another friction model curve 210 that represents friction bias force predictive values using the modified friction model of equation 2 and the non-local memory (NLM) techniques with trimming as discussed above. As before, the curve 210 is plotted against the position x-axis 202 and friction amplitude y-axis 204. It can be seen that the slopes of the interior segments, and the end point alignments, are improved as compared to the base curve 200 in FIG. 7.

It has been established empirically that the modified model as represented by curve 210 in FIG. 9 better conforms to actual device behavior over the base model curve 200 of FIG. 7. In some cases, 3σ deviation error was reduced using the model of FIG. 9 by about 40% over the base model of FIG. 7. Such reduction is achieved without any change to alpha table or B_{c}, so the enhanced model can be applied to products that have already been calibrated with the base Dahl model of equation 1.

A feature of friction models based on the Dahl approach is the hysteresis extent (B in the formula) can be adapted on the fly, which gives the Dahl model the flexibility to adapt the shape of the transition curve. It has been found that the hysteresis extent can change significantly over temperatures and the lifetime of a device such as the storage device 110 (see FIG. 2). Adaptation of the model over time can be implemented in a straightforward manner.

In some cases, the hysteresis extent can be adjusted in a desired direction (increased or decreased) based on the sign of the bias length term, instead of the sign of bias force term. When the position is within the outmost hysteresis loop, the predicted bias force does not remain symmetrical relative to the origin. It follows that one way to determine whether the transition curve is along the OD bound (e.g., portion 210A) or ID bound (e.g., portion 210B) is by checking the sign of the bias length (e.g., the distance since last direction change).

In further cases, the updated bias force history can be saved in the stack during adaptation. When the hysteresis extent has been adapted to a new value, the stack may need to be refreshed to reflect the new B_{c}. This can be formulated as follows:

B_{new}=[−B_{c}sgn(Δx₀)−B_{c}sgn(Δxₒ)]α(|x₀|)+B_{c}sgn(Δx₀)−(−B_{c}sgn(Δx))+B_{dirChange0} (Eq. 3)

B_{new}=B_{new}×(2(1−α(|Δx₀|))sgn(Δx₀))+B_{dirChange0} (Eq. 4)

If B_{dirChange0} is expressed as:

B_{dirChange0}=B_{c}×(2(1−α(|Δx₁|)sgn(x₁))+B_{dirChange1} (Eq. 5)

and define,

f(Δx)=2(1−α−(|Δx₀|)sgn(Δx) (Eq. 6)

it follows that

B_{new}=B_{c}f(Δx₀)+B_{c}f(Δx₁)+B_{dirChange1}

B_{new}=B_{c}f+B_{c}f(Δx₀)+B_{c}f(Δx₁)+B_{c}f(Δx₂)+B_{dirChange2}

B_{new}=B_{c}f+B_{c}f(Δx₀)+B_{c}f(Δx₁)+B_{c}f(Δx₂)+ . . . B_{dirChangeN} (Eq. 7)

According to the non-local memory property, eventually,

B_{dirChangeN}=B_{c}sgn(Δx_{N}) (Eq. 8)

when the value reaches the head of the history stack, and Δx_{N} is the maximum hysteresis length. Thus,

B_{new}=B_{c}(f(Δx₀)+f(Δx₁)+ . . . +(Δxₙ₋₁)−sgn(Δx_{N})) (Eq. 9)

where Δx₁ is the bias length at each velocity reversal location, N is the depth of the stack, and B_{c} is a scalar value in the modified friction model. To refresh the bias force stack, each of the terms in the stack can be multiplied (scaled) by the value B_{c}_{_{new}}/B_c_{old}.

Even when B_{c} is seeded with a wrong value, the model can adapt to the correct value (with prediction error drops to closed to 0) without divergence. It has been observed that the adaptation can be completed within 1000 random seek within the outmost hysteresis loop (e.g., portions 210A, 210B).

While the B_{c} term can be adapted on the fly, it is contemplated that the alpha table may be calibrated beforehand. The modified model with NLM (e.g., equation 9) does not necessarily require any substantive changes to the alpha table, although it has been noted that noise can affect the calibration process.

Typically, random seeks that extend along the outmost hysteresis loop (e.g., portions 210A, 210B) can be used during calibration processing, albeit with the presence of some levels of noise. Because the alpha table often cannot be directly applied when there is incomplete travel across the hysteresis region prior to a direction change, calculating the alpha table during such shorter seeks can be problematic. In other words, a better way to calibrate the alpha table may be to use measured bias friction from seeks (and the following seeks in the same direction) that have complete traveled across the hysteresis region prior to direction change (e.g., from points A to B and vice versa in FIG. 9).

While the respective proposed friction models of equations 2 and 9 can provide enhanced friction estimates for seeks, other approaches are contemplated as well.

An alternative approach provided in accordance with some embodiments employs a Dahl friction model as discussed above for longer seeks (e.g., the base Dahl model, the modified Dahl model as in equation 2 or the modified Dahl model with NLM as in equation 9), and employs a different model, such as a modified Leuven model, for shorter seeks.

As noted above, the Dahl model was developed for adaptive friction compensation in various control systems such as servo systems with ball bearings. The Dahl model shows a hysteresis-like behavior when the extreme points lie symmetrically with respect to the origin, which does not always agree with experimentally observed behavior.

In accordance with further embodiments, an alternative friction model is proposed that can be used in lieu of, or in combination with, the friction models discussed above. This alternative friction model is based on the so-called Leuven (Swevers) friction model, which can be expressed as follows:

$$F = {F}_{h} ( z ) + {σ}_{1} \frac{d z}{d t} + {σ}_{2} ν \qquad ( Eq . 10 )$$

where F is the friction force at a given sample, Fₕ(z) is the hysteresis friction force, are micro-viscous and viscous damping coefficients, and

$$ν ( = \frac{δz}{d t} )$$

is the velocity of the control object (e.g., actuator 136). This provides a non-linear state equation:

$$\frac{d z}{d t} = ν ( 1 - sgn ( \frac{{F}_{h} ( z )}{S ( ν )} ) * \vert \frac{{F}_{h} ( z )}{S ( ν )} {\vert}^{n} ) \qquad ( Eq . 11 )$$

(steady state vs. constant velocity) with

S(v)=F_{c}+(Fₛ−F_{c})e^{-(-(v/v}^{ₛ}⁾^{^{ζ}} (Eq. 12)

where Fc is Coulomb friction, Fs is static friction, vs is the Stribeck velocity and ξ is a constant. The Leuven friction model employs a stack memory (e.g., stack 192) having a counter that increases at each direction reversal. Each direction reversal initiates a new transition curve, adds a new extreme to the hysteresis memory stack, and resets the state variable z to zero.

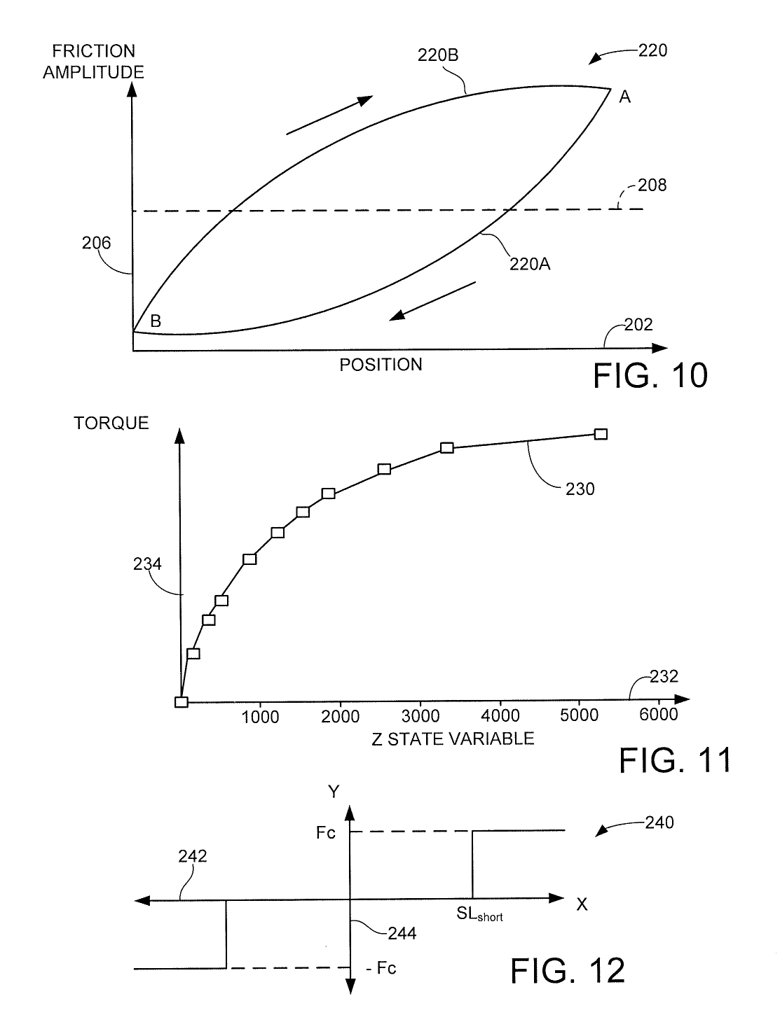

The Leuven model provides a friction force curve such as 220 in FIG. 10. It will be noted that the curve 220 (plotted against axes 202, 204) exhibits symmetry about line 208 for any arbitrary points A and B, and does not include smaller interior loops as in FIGS. 7 and 9. That is, portions 220A and 220B are symmetric about mid-line 208 and are adjusted as required for seek length (distance from A to B).

The stack counter decreases at the closing of each loop. That is, at the closing of an internal loop, the associated extreme values are removed from the stack. The value of z is recalculated such that the new transition curve continues on the previous curve before the diversion. This is similar to the implementation of non-local memory (NLM) discussed above. At the maximum hysteresis points (e.g., A and B in FIG. 10), the hysteresis model is reset for strictly positive (respectively, strictly negative) velocities versus when the hysteresis friction force Fₕ (z) reaches a maximum (or respectively, a minimum).

In order to implement this friction model, the friction transition curve (F_{d}) together with a number of parameters (σ₁, σ₂, Fₛ, F_{c}, vₛ, ζ) should be calibrated. This can be a non-trivial task because the model is not only highly nonlinear, but also in-drive friction measurements are not easily carried out during seek operations. Often, an in-drive friction measurement is available only at the end of seek by averaging the integrator output as the friction acts as an actuator bias.

One solution is to measure steady-state friction over a number of sequential, relatively short seeks (e.g., a few tracks) and calculating a value Fd(z), representing the friction transition curve, through z-domain conversion of the following relation:

$$z = ΣΔ z , Δ z = Δ x ( 1 - ( \frac{f}{{F}_{s}} ) ) \qquad ( Eq . 13 )$$

The calibrated friction transition curve 220 (“modified Leuven model”) can provide an accurate bias hysteresis prediction for short seeks where the friction is a dominant non-linear factor. It has been found, however, that the modified Leuven model does not always work as well when seek length becomes longer. For longer seek lengths, the hydrodynamic influence from the bearing lubricant may start to play a significant role in lowering the friction level, and therefore in this case the friction model typically over-predicts relative to the actual friction experienced by actuator bearing.

Accordingly, a different model can be used for relatively longer seeks, such as the base Dahl friction model, the modified Dahl friction model discussed above (equation 2), the modified Dahl friction model with NLM (equation 9), or some other friction model such as a static friction model (e.g., friction is assumed to be a selected steady-state value).

Suitable transition points between different models can be selected empirically. In some cases, it has been found that the friction reduces to a small level at the transition from short seeks to long seeks, but in an opposite transition direction the friction can require a certain time interval to recover its steady state level. Thus, changes between models can take into account changes in seek direction, and different transition points may be implemented accordingly.

In further embodiments, transitions from the short seek model to the long seek model can be carried as follows. First, the memory stack (e.g., stack 192) is cleared. Second, the z state is reset to zero (0). Third, the bias hysteresis force Fₕ from the Dahl friction model (or modified models) is selected. Fourth, the value F_{b} is set equal to the value Fₕ.

Transitioning from the long seek model to the short seek model can be carried out as follows. First, continue to use the long seek model until the accumulated number of successive short seeks SLₛₕₒᵣₜ reaches a selected threshold, and then second, transition to the short seek (modified Leuven) model. This can be represented as follows:

$${F}_{hysteresis} = \{ \begin{matrix}{F}_{Leuven} ( z ) , & if Δ x \leq {SL}_{short} , n \geq {N}_{short} \\ {F}_{long} ( x ) , & Otherwise\end{matrix} \qquad ( Eq . 14 )$$

where Δx is the length of each seek, n is the number of consecutive short seeks, and F_{Leuven}(z) is given by the relation:

$$\begin{matrix}{F}_{Leuven} ( z ) = {F}_{b} + {F}_{d} ( z ) \\ with & ( Eq . 15 ) \\ \frac{d z}{d t} = ν ( 1 - sgn ( \frac{{F}_{Leuven} ( z )}{{F}_{s}} ) \times \vert \frac{{F}_{Leuven} ( z )}{{F}_{s}} {\vert}^{n} ) . & ( Eq . 16 )\end{matrix}$$

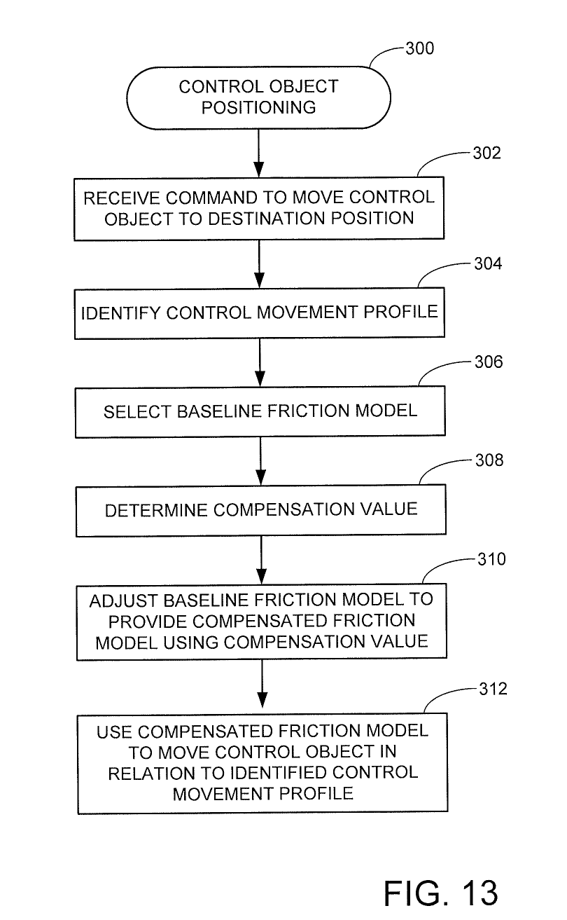

Examples of the respective short and long seek models of equation (14) in accordance with some embodiments are represented in FIGS. 11 and 12. FIG. 11 shows a friction transition curve 230 for short seeks plotted against a z state variable x-axis 232 and a torque y-axis 234. The curve 230 is reset at each direction change. The shape of the curve 230 is determined based on F_{d}(z), and the values F_{d}(z) and Fₛ are calibrated using short seeks as discussed above.

FIG. 12 shows an example static friction model curve 240 against position x-axis 242 and friction amplitude y-axis 244. Fc and −Fc represent the static friction values which may be calibrated using long seeks. SLₛₕₒᵣₜ is the cut-off point to transition between the two models. As desired, the static friction model can be used for longer seeks.

In still further embodiments, an adaptation strategy can be used to make the above friction model robust against time and/or environment-dependent variation of bias hysteresis. When using a friction model with nonlocal memory implemented in a form of memory stack, the development of an adaptive model can become difficult because the memory stack in the friction model is not only highly nonlinear but also contains the direction reversal data from past seeks.

The adaptation strategy proposed herein introduces an adaptive scalar (y) which is multiplied with the Leuven friction output (F_{Leuven}) to provide the final hysteresis force (F_{hysteresis}) Note that the memory stack is filled with the F_{Leuven} not the F_{hysteresis} value. This way, the hysteresis memory stack is independent of the adaptation. In other words, the Leuven friction calculation can be carried out separately from the final bias hysteresis output by multiplying the Leuven friction with the adaptive constant.

The adapted Leuven friction model can be incorporated in the feed-forward servo control model used to control the current applied to the VCM as in FIG. 6. The servo control model can use an integrator to output current samples. In sum, the process can be represented as follows:

$${F}_{hysteresis} = \{ \begin{matrix}{F}_{Leuven} ( z ) , & if Δ x \leq {SL}_{short} , n \geq {N}_{short} \\ {F}_{long} ( x ) , & Otherwise\end{matrix} \qquad ( Eq . 17 )$$

where Δx is seek length, and n is the number of consecutive short seeks.

γ(k+1)=γ(k)+μPredictionError(k)*BiasHysteresisModel(k) (Eq. 18)

where k is the short seek number.

$$\{ \begin{matrix}PredictionError ( k ) = IntegratorOutput ( k ) - IntegratorOutput ( k - 1 ) \\ BiasHysteresisModel ( k ) = {F}_{Leuven} ( z ( k ) )\end{matrix} \qquad ( Eq . 19 )$$

The gain (γ) and/or the prediction error can be logged during drive operation to monitor the performance of the system. It has been found empirically in some calibrated systems such as 100 (FIG. 2), the new bias hysteresis compensation can provide on the order of a greater than 7% random right IOPS improvement under 1% capacity at ambient temperature.

FIG. 13 provides a flow chart for a CONTROL OBJECT POSITIONING routine 300, generally illustrative of steps that may be carried out in accordance with the foregoing embodiments. The routine can employ the various respective models and position a variety of control objects.

For purposes of providing a concrete example, the routine will be discussed in terms of a control operation (seek) to move a selected data transducer from the data storage device 110 of FIG. 2 from an initial position to a destination position using a seek control assembly 180 as depicted in FIG. 6. The device may be configured to selectively employ all of the various friction models discussed above, or may be configured to select less than all of these friction models, as required.

A command is received at step 302 to move the control object (transducer 124) to a destination track. The command may be associated with a particular host read or write command to transfer data with the media 116, or for some other purpose. It is contemplated that during normal device operation, a plurality of pending commands may be placed in a queue and a command selection strategy may be carried out to place the seek commands in a suitable order.

In some cases, short seeks may be grouped together to be carried out consecutively in order to employ one model over another and enhance data I/O performance. For example, the seeks may be grouped to meet the consecutive number of short seeks constraints of the modified Leuven model as discussed above.

A control movement profile is next selected at step 304. It is contemplated that this may include the selection of a velocity controlled profile, a model reference profile, etc. A baseline friction model is next identified at step 306. The selected baseline friction model may be based on the seek length, control movement profile type, seek direction, etc. and may include the aforementioned Dahl friction model, the Leuven friction model, the static friction model, etc.

A compensation value is next determined at step 308. In the case of the modified Dahl friction model, this may be generated in accordance with the discussion of equation 2 where the term (2) is provided to account for the real B_{dirChange}. Additionally or alternatively, this may be carried out using the modified Dahl friction model with non-local memory (NLM) where the memory stack (e.g., stack 192) is used to generate the B_{new} value. In the case of the modified Leuven friction model, the compensation value may be the adapted friction transition curve F_{d} which is discussed above in Equation 13 et seq. and FIGS. 10-11. In the context of the static friction model of FIG. 12, the compensation value may be a calibrated F_{c} value.

The baseline friction model from step 306 is next adjusted at step 310 using the compensation value from step 308 to provide a compensated friction model. The compensated friction model is thereafter used at step 312 to move the control object (transducer 124) to the destination position.

It will now be appreciated that the various embodiments presented herein can provide a number of benefits. By modifying a base friction model with one or more compensation values, a modified friction model can be derived that provides improved control object positioning performance. In some embodiments, a first model can be used for relatively shorter control path distances (e.g., seek lengths) and a different, second model can be used for relatively longer control path distances (e.g., seek lengths). While various embodiments disclosed herein have been in the environment of a hard disc drive, such is merely exemplary and not limiting as the techniques provided herein can be adapted for use in any number of rotational friction environments.

It is to be understood that even though numerous characteristics and advantages of various embodiments of the present disclosure have been set forth in the foregoing description, together with details of the structure and function of various embodiments of, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising:
calculating a compensation value for a baseline friction model which predicts friction in a positioning system;
generating a modified friction model based on the compensation value and the baseline friction model; and
moving a control object of the positioning system from an initial position to a final position responsive to a trajectory profile calculated using the modified friction model.

2. The method of claim 1, wherein the baseline friction model is a Dahl friction model for a base seek length, the modified friction model is a modified Dahl model, and the compensation value compensates for errors in the baseline Dahl friction model for a shorter seek length less than the base seek length.

3. The method of claim 2, wherein the compensation value provides a friction transition curve slope for the shorter seek length that nominally matches a slope of a transition curve corresponding to the base seek length.

3. The method of claim 1, wherein the baseline friction model is a Dahl friction model for a first seek length, the modified friction model is a modified Dahl model, and the compensation value is calculated from entries successively stored in a non-local memory (NLM) stack.

4. The method of claim 3, wherein pairs of adjacent entries in the NLM stack are removed responsive to a seek length exceeding a predetermined value.

5. The method of claim 1, wherein the baseline friction model is a first friction model used for seeks of a first length, and a different, second friction model is used for seeks of a different, second length.

6. The method of claim 5, wherein the first length is shorter than the second length.

7. The method of claim 5, wherein the first length is longer than the second length.

8. The method of claim 5, wherein the second friction model is based on a Dahl friction model.

9. The method of claim 5, wherein the second friction model is based on a static friction model.

10. The method of claim 1, wherein the baseline friction model is a Leuven friction model used for relatively short seek lengths, the modified friction model is a Leuven friction model, and the compensation value comprises a friction transition curve having a calibrated slope calculated based on a z transform of data obtained over a plurality of relatively short seeks.

11. The method of claim 10, wherein a transition is made to a different, second friction model responsive to an accumulated total number of consecutive shorter seeks reaching a predetermined threshold.

12. The method of claim 1, wherein the control object comprises a data read/write transducer moveable adjacent different tracks defined on a rotatable magnetic data recording medium.

13. An apparatus comprising:
a moveable control object; and
a positioning system adapted to move the control object from an initial position to a destination position during a seek responsive to a trajectory profile, the positioning system calculates a compensation value for a baseline friction model which predicts friction in the positioning system, generates a modified friction model based on the compensation value and the baseline friction model, and calculates the trajectory profile using the modified friction model.

14. The apparatus of claim 13, wherein the positioning system comprises a seek controller in a data storage system used to carry out seeks to move a data read/write transducer to different tracks on a rotatable data storage medium.

15. The apparatus of claim 13, wherein the baseline friction model is a Dahl friction model for a base seek length, the modified friction model is a modified Dahl model, and the compensation value compensates for errors in the baseline Dahl friction model for a shorter seek length less than the base seek length.

16. The apparatus of claim 13, wherein the baseline friction model is a first friction model used for seeks of a first length, wherein the positioning system uses a different, second friction model for seeks of a different, second length.

17. The apparatus of claim 16, wherein the first friction model is based on a Leuven friction model, and the second friction model is based on a Dahl friction model.

18. The apparatus of claim 13, wherein the baseline friction model is a Leuven friction model used for relatively short seek lengths, the modified friction model is a Leuven friction model, and the compensation value comprises a friction transition curve having a calibrated slope calculated based on a z transform of data obtained over a plurality of relatively short seeks.

19. The apparatus of claim 18, wherein a transition is made to a different, second friction model responsive to an accumulated total number of consecutive shorter seeks reaching a predetermined threshold.

20. The apparatus of claim 13, further comprising a friction model block and a memory stack, wherein the friction model block generates a succession of estimated friction values responsive to a combination of entries successively stored in the memory stack.
